(19) United States
(12) Patent Application Publication
(10) Pub. No.: US 2018/0089215 A1
(43) Pub. Date: Mar. 29, 2018

(54) METHOD AND APPARATUS FOR VISUALIZATION AND REDUCTION OF SPACE USED BY HIERARCHICAL DATA IN A NESTED FILE SYSTEM

(71) Applicant: Michael Moon, San Diego, CA (US)

(72) Inventor: Michael Moon, San Diego, CA (US)

(21) Appl. No.: 15/279,331

(22) Filed: Sep. 28, 2016

(51) Int. Cl. G06F 17/30

(52) U.S. Cl. CPC G06F 17/30126; G06F 17/30117; G06F 17/30221; G06F 17/30138

(57) ABSTRACT

Embodiments of a method and apparatus which enable a layperson to visually quantify and reduce use of physical space for reading and storing information on their computer device are provided. Interactive elements of the invention may be consolidated and/or reproduced for display in response to user-generated instructions in a single window on a graphical user interface (“GUI”) and may be responsive to user selections such as applying a color scheme to the visual display and saving a selection of one or more favorite folders or drives to analyze. Additional operations may be automatically performed, such as saving one or more recently analyzed folders or drive and regenerating a visual display each time a folder or drive selection is made.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to computer resource management and, more particularly, to systems, methods, and apparatuses which both generate interactive, graphical representations of physical space occupied by digital data and further enable deletion of selected data in a consolidated user interface.

### BACKGROUND

Contemporary advancements in computing technology have made personal electronic devices widely available at reasonable cost to many people who might not be considered by those skilled in the art of computing technology to be “computer savvy.” As a result, various software applications and other programs have been made available to enable communication, personal organization and even recreation. Indeed, obtaining access to software applications and other programs, such as by downloading it onto a laptop, desktop, or tablet computer, is often as simple as pressing a button. While this process may seem abstract to a lay-user, it is well known that electronic applications and programs, including user-generated content such as electronic files, occupy physical space on electronic storage devices, including hard drives, solid-state disk (“SSD”), USB drive and other storage media.

As the process of gaining access to and saving files, folders, applications and programs becomes simpler, however, so too does reaching storage capacity on a computing device. This can be problematic because nearing capacity or filling a certain percentage of available storage space may affect processing capabilities of the computing device, often rendering a computer's performance frustratingly slow and cumbersome, not to mention preventing storage of additional applications, programs, and other content. Unfortunately, the intangible nature of storing electronic data, and common methods of nesting related files and folders within one another, makes clearing storage space difficult to execute for the common user.

Proposals to solve this problem have included new electronic applications and programs operative to list data stored on a computing device, for example, by name and size, enabling a user, to some extent, to see what is taking up space on his or her storage device. Still, many of those have failed to provide adequate means for optionally clearing portions of illustrated data from storage. Furthermore, prior suggestions for visualizing the space used has been difficult to understand and navigate. Thus, there remains a need for a method and apparatus that enable visualization of space used as well as permit easy reduction of space used in a computing device.

### SUMMARY

The present disclosure is directed to systems, methods, and apparatuses that enable a layperson to visually quantify and reduce the amount of physical space used for storing information on their computing device. In particular, the system and method are operative to display hierarchical data such as files, folders, and subfolders in relation to parent folders, drives, and/or directories that they may be digitally nested within, and further enable optional deletion of files, folders, subfolders, drives, and directories in a consolidated user interface. It is contemplated that consolidating functionality in a single window on the user interface will simplify and add efficiency to the process of monitoring electronic storage.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

One embodiment of the invention is a computer readable program operative to present a visual representation of the size and relative location of a selected item such as a digital file, folder, subfolder, or even directory stored in a computing device. Typically, digital data is methodically stored and retrieved on the computing device, such as a desktop, laptop, and tablet computer, and even a smartphone, according to a file system (or filesystem). Those skilled in the art will recognize that although many different computing device manufacturers and programmers practice proprietary directory and file systems, it is contemplated that the disclosure may be used to visualize and reduce, if desired, the volume of data stored in any type of file system.

Many computing devices permit hierarchical storage of files, folders, and directories. That is, files, folders, programs, and other digital elements may be nested or catalogued within other, often related, folders and directories. This creates a parent-child or organizational tree-type relationship among stored components. In accordance with one embodiment, then, upon receiving a selection of a stored file, folder, subfolder, directory, or drive, (hereinafter “item” for the sake of brevity), a visual representation or visualization of elements comprising the selection may be generated or displayed.

Owing to the hierarchical nature of typical computer storage, it is contemplated that visualization of the selection and elements catalogued therein may be defined by a sunburst chart. More particularly, the item selected may be considered the root of the hierarchy for the generated visualization, and therefore the center of the chart. Any element, that is, subfolder, subdirectory, program, and application, contained within the root selection may then be depicted in the defining sunburst chart as concentric arcs encircling the root. In an embodiment, the length of each arc may be determined by the digital size in terms of units of digital information of each element. Thus, larger elements will appear proportionally longer than smaller elements. Additionally, in order to visually communicate the location of stored elements within the root selection, it is contemplated that the concentric arcs may be layered around the central root according to hierarchy. For example, in the event that the root is a folder, any subfolders, programs, files, and other data catalogued within the folder may be depicted as proportionally-sized arcs directly encircling the root in a first level of the sunburst chart. Any files, folders, programs and other data catalogued within each of the first level elements may then be depicted as proportionally-sized arcs directly encircling the root and so on for as many levels stem from the root selection. It should be noted that for ease of visually comparing the size of each element and location with respect to the root selection, each child will radiate in line with its parent.

In one embodiment, elements comprising the root may be themselves selected to provide a more limited, or even specific, view of stored data. In such a case, a starburst chart may be generated and defined by the selected element as a new root. Each concentric arc, then, may comprise child elements of the new root. Narrowing the scope of the starburst chart may continue to any extent desired by a user. It is contemplated, though, that selecting any new root, or center of the starburst chart, may regenerate the previously generated starburst chart so that additional elements may be viewed and/or selected as desired.

In some embodiments, upon selection of an item to be visualized, a listing of elements catalogued therein may also be displayed. Likewise, selection of an element and generation of a visualization defined by a new root may be accompanied by a listing of elements catalogued within the new root.

It may be desirable to further display bibliographic information, such as a name or label, date last modified, and even digital size for any selected items and/or elements. This may be particularly desirable for lay-users who find virtual navigation through hierarchical file systems to be disconcerting or otherwise burdensome due to their abstract and intangible nature.

Having visually assessed a digitally stored item and any children catalogued therein, a user may determine whether they would like to free physical storage space by selecting items and/or elements to delete. Proportionally sizing each arc in the sunburst chart may aid this process by illustrating which data are occupying the most space. Indeed, upon receiving instructions to delete one or more elements, a hierarchical visualization may be generated with the deleted items removed so that storage capacity can be assessed and reassessed over the course of selective analyzation of the file system.

In some embodiments, features and functionality comprising the invention may be consolidated and/or reproduced for display in response to user-generated instructions in a single window on a graphical user interface (“GUI”) of the computing device. It is contemplated that this provides a user with a streamlined process for freeing storage, avoiding a need to electronically navigate between multiple windows and displays.

In some embodiments, the computing device may be responsive to user selections for applying a color scheme to the visual display and saving a selection of one or more favorite folders or drives to analyze. Additional operations may be automatically performed, such as saving one or more recently analyzed and/or user-selected favorite items, elements, roots, parents, or children, as the case may be.

Thus, it is an object of the invention is to simplify the experience of clearing physical storage space on a computing device.

Another object of the invention is to ease repeat analyzation of certain folders and drives.

Still another object of the invention is to unify beneficial features and functionality in a single visual display.

Yet another object of the invention is to personalize a user's experience of clearing physical space on a computing device.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows an exemplary embodiment of a computer in which an exemplary method for visualization and reduction of spaced used by stored data may be performed.

FIG. 2 is a flowchart depicting an exemplary embodiment of a method for visualization and reduction of space used by stored data.

FIG. 3 illustrates an exemplary user interface for the method for visualization and reduction of space used by stored data.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

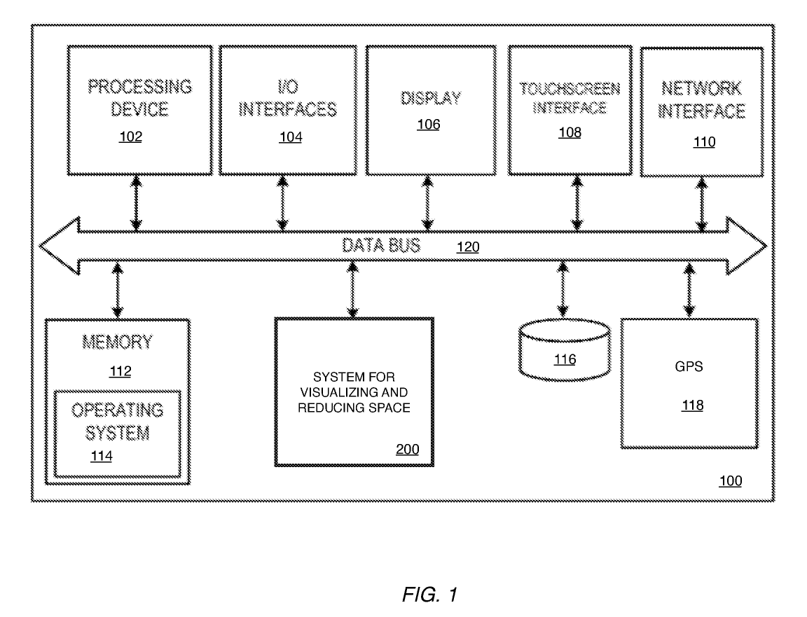

FIG. 1 illustrates one embodiment of a computing device 100 operative to perform the method for visualization and reduction of space used in a nested file system. The computing device 100 may be a tablet, laptop, or desktop computer, a smartphone, or any other of a wide variety of wired and/or wireless computing devices.

The computing device 100 may include a processing device (processor) 102, input/output interfaces 104, a display 106, a network interface 310, a memory 112, and operating system 114, a mass storage 116. Each element is configured to communicate across a local data bus 120. Additionally, the computing device 100 incorporates a system for visualizing and reducing space used by stored data 200, although the location of information 136 could vary.

The processing device 102 may include any custom made or commercially available processor, a central processing unit (CPU) or an auxiliary processor among several processors associated with the computing device 100, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 112 can include any one of a combination of volatile memory elements (e.g., random-access memory (RAM, such as DRAM, and SRAM, etc.)) and nonvolatile memory elements. Non-volatile memory elements tasked with long-term persistent storage in particular, whether permanently housed with the operative parts of the computing device or external yet electronically communicable with such device, including computer-readable storage media, will be known to those skilled in the art to contain the hierarchical data subject to this disclosure.

The memory typically comprises native operating system 114, one or more native applications, emulation systems, or emulated applications for any of a variety of operating systems and/or emulated hardware platforms, emulated operating systems, etc. For example, the applications may include application specific software which may comprise some or all the components of the computing device 100. In accordance with such embodiments, the components are stored in memory and executed by the processing device. Note that although depicted separately in FIG. 1, the system and method for visualizing and reducing space used by stored data 200 may be resident in memory such as memory 112.

Some embodiments of the computing device 100, for example, smartphones and tablet computers, may further include a touchscreen interface 108 and an GPS 118. In such embodiments, a touchscreen interface 108 may be configured to detect contact within the display area of the display 106 and provides such functionality as on-screen buttons, menus, keyboards, etc. that allows users to navigate user interfaces by touch. For some embodiments, the computing device 100 will comprise GPS 118 or other means to determine the location of the computing device 100.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 1, network interface device 110 comprises various components used to transmit and/or receive data over a networked environment, examples of which will be known to those skilled in the art. When such components are embodied as an application, the one or more components may be stored on a non-transitory computer-readable medium and executed by the processing device.

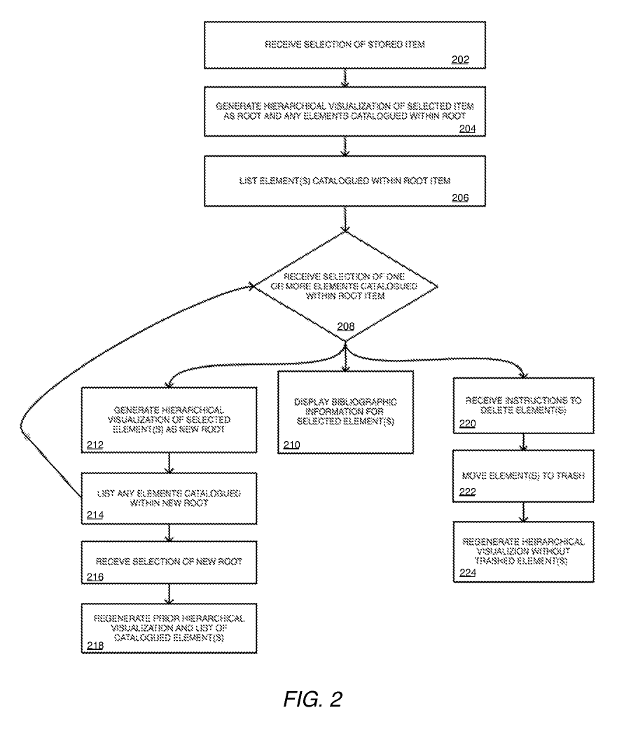

FIG. 2 is a flowchart depicting an exemplary embodiment of a method for visualization and reduction of space used in a tiered storage system such as may be performed by an electronic computing device 100 in FIG. 1. Additionally, the system 300 is operative, at least in part, to perform the method depicted in the flowchart of FIG. 2. Specifically, the method includes the steps of receiving a selection of a stored item (block 202) such as any of those directories, folders, subfolders, files, programs and applications which may be stored in a form of non-volatile memory; generating a hierarchical visualization of the selected item, such item defining a root, and any elements catalogued within the root (block 204); and listing any elements catalogued within the root (block 206). Depending on a user's particular needs, various outcomes may be possible upon receiving a selection of one or more elements catalogued within the root (block 208). For instance, bibliographic data, including name, size in units of digital information, date created, latest date and time accessed, and latest date and time modified may be displayed (block 210). Of course one skilled in the art will recognize that more or less bibliographic data, in terms of quantity and detail, may be provided. The foregoing are offered by way of example only and not of limitation.

As another possible outcome of receiving a selection of one or more elements catalogued within the root (block 208), a hierarchical visualization of the selected element defining a new root, and any elements catalogued within such new root may be generated (block 212). In other words, when a child of a root or parent folder or directory is selected, a visualization focusing on any subsequent children may be generated. Any elements catalogued within the new root may be listed (block 214). The method may further comprise receiving a selection of the new root itself (block 216) in the event that a user wishes to regenerate to the prior, broader hierarchical visualization and list of any catalogued elements (block 218). It is contemplated that blocks 212, 214, 216, and 218 may be performed for any element and any resulting new root as desired, as demonstrated by the direct connection between blocks 214 and 208.

Still another possible outcome of receiving a selection of one or more elements catalogued within the root (block 208) may be to receive instructions to delete the selected element or elements (block 220). Such instructions may result in moving selected elements to a digital trash bin (block 222), and may even further result in regenerating visualization of hierarchical data without such trashed elements (block 224).

It is contemplated that selection of any item or element may occur according to a variety of methods of digital selection known in the art. For instance, selection may occur when a user digitally clicks an element or item. Selection may occur when a user digitally hovers over an element or item. In the even that the computing device display is a touchscreen, selection may occur when a user physically presses an element or item. Likewise, commands or instructions to the system may be carried out in a variety of manners, such as dragging and dropping or simply selecting in response to digital prompting. Thus, the invention should not be limited by the manner of selection or instruction.

If embodied in software, it should be noted that each block depicted in the accompanying flowchart represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the computing device 100 of FIG. 1. The machine code may be converted from the source code, etc. If embodied in hardware, each block may represent a circuit or a number of interconnected circuits to implement the specified logical function(s). Additionally, although the flowchart shows specific orders of execution, it is to be understood that the orders of execution may differ.

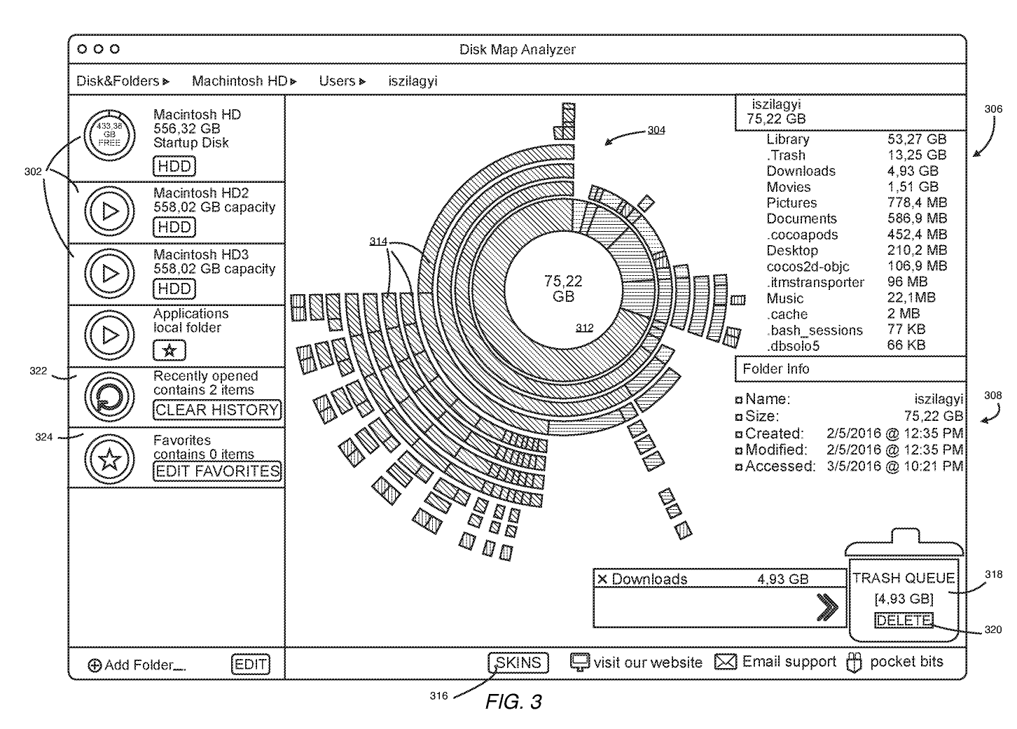

Each of the functions and elements discussed above may be better understood in reference to an exemplary user interface. Specifically, FIG. 3 illustrates an exemplary user interface for visualizing physical storage on a computing device according to one embodiment. Accordingly, the system and method disclosed may provide interactive content to intuitively enable visualization and reduction of space used within a single, unified and/or consolidated digital window on the display of an exemplary computing device. Providing, generating, and displaying results based on user selections in a consolidated application window in this manner may ensure that a layperson can easily clear data otherwise occupied by digital items and elements that they can remove.

One embodiment of the user interface contemplated for the system, method and apparatus comprises is configured to display a listing of digital items available to analyze 302, a hierarchical visualization of selected items as a starburst chart 304, and information related specifically to elements illustrated in the starburst map generated, such as a listing of elements 306 as well as bibliographic data 308 of individually selected elements. It is contemplated that this information can be generated by hovering, pressing, or clicking on items and elements, either from among the displayed listing or even illustrated arcs, as the case may be, as discussed above. As illustrated, the sunburst chart 304 is defined by a series of concentric arcs 310. Each arc may represent catalogued data in terms of hierarchy. For example, the center 312 of the sunburst chart 304 may represent the root, or parent, shared by each of the catalogued elements, or children, depicted by the layered and concentric arcs 314. Working outward from the center, then, each layer of arcs may represent data nested in each prior layer. To aid visualization of storage usage, each arc may be proportionally sized to illustrate the relative space used by each element, or child.

Additionally, a user may select a color scheme, or skin 316 to the hierarchical visualization. This may help the user visually distinguish between types of stored data. For example, programs and applications may be colored differently than files and folders, though one skilled in the art will recognize that a desirable color scheme may be applied to the visualization in a variety of manners without departing from the invention. Some colors may be avoided to support ergonomic use, for example, or even accommodate users with certain visual impairments, in some embodiments. It is further contemplated that colors may be applied to the element listing and bibliographic data so that the color of an element or item in the visualization may correspond to the color of its name in the list, and so on. Each of these contemplated functionalities may streamline a user's application of the system and method in analyzing their digital storage space.

In the event that a user desires to free physical space by deleting any item or element listed or visualized, they may select the desired item or element and place it, by dragging and dropping it, in the trash 318. The user can confirm deletion by clicking or pressing “delete” 320.

As discussed above, some embodiments of the system and method may store information relating to recently analyzed items 322, and even favorite 324 or frequently analyzed items. It is contemplated that this may increase efficiency and ease of storage space analyzation over repeated uses. In some embodiments, such information may be automatically collected and stored. For example, the system and method may be optionally or automatically configured to save one or more of the most recently analyzed items. The system and method may alternatively be configured to save each of the items analyzed within a particular time frame, such as the last day, number of days, week or number of weeks, month or number of months, or as long as may be desired.

In some embodiments the system and method may include or otherwise be configured to receive instructions to store a list of files, drives, or directories to analyze. These might be selected from among those directories, files, and drives that are, for example, most frequently accessed when using his computing device. Of course, recent 322 and favorite 324 items to analyze may be determined via a variety ways known to those skilled in the art. Indeed, one skilled in the art will additionally recognize that other desirable categories may be included, the foregoing are offered by way of example only and not of limitation.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the quality and quantity of folders, files, and even disks saved to a recently analyzed or favorites portion of the method and apparatus may vary depending on a user's personal preferences. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the method and apparatus for visualization and reduction of space used by stored data with which that terminology is associated. In general, the terms used in the following claims should not be constructed to limit the method and apparatus for visualization and reduction of space used by stored data to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the method and apparatus for visualization and reduction of space used by stored data is not intended to be exhaustive or limited to the precise form disclosed above or to a particular field of usage.

While specific embodiments of, and examples for, the method and apparatus are described above for illustrative purposes, various equivalent modifications are possible for which those skilled in the relevant art will recognize.

While certain aspects of the method and system disclosed are presented below in particular claim forms, various aspects of the method and apparatus are contemplated in any number of claim forms. Thus, the inventor reserves the right to add additional claims after filing the application to pursue such additional claim forms for other aspects of the method and apparatus for visualization and reduction of space used by stored data.

What is claimed is:

1. A method for visualizing and reducing space used in a nested file system, comprising:
at a computing device:
receiving a selection of a stored item, the stored item defining a root;
generating, on a display of the computing device, a hierarchical visualization of the root and any elements digitally catalogued within the root;
listing each element digitally catalogued within the root;
receiving a selection of one or more elements catalogued within the root;
displaying bibliographic information defining any selected elements.
generating, on the display, a hierarchical visualization of the one or more selected elements as a new root and any elements digitally catalogued within the new root;
responsive to receiving a selection of the new root, regenerating the previously generated hierarchical visualization and list of one or more catalogued elements; and
responsive to receiving instructions to delete one or more elements catalogued in a root, transferring the one or more elements from storage within the root to the trash and regenerating the hierarchical visualization with such one or more elements removed;
wherein the hierarchical visualization, list of elements contained within the root, bibliographic information, and trash are consolidated for display within a single digital window.

2. The method of claim 1, wherein the hierarchical visualization of the any of the root and new root and any elements digitally catalogued therein comprises a sunburst chart, wherein the root or new root, respectively, defines a center and each element respectively catalogued within the root and new root defines an arc, each arc concentrically radiating from the center and stacked away from the center at a level corresponding to its hierarchical position with respect to the root or new root.

3. The method of claim 1, further comprising the steps of receiving a selection of a color scheme, wherein the hierarchical visualization and listing of elements are respectively defined by the selected color scheme.

4. A system for visualizing and reducing space occupied by stored data, comprising:
a computing device having a display defined by a graphical user interface, the device operative to, within a single window displayed on the graphical user interface:
receive a selection of a digitally stored item, the selected item defining a root;
list each element digitally catalogued within the root;
generate a sunburst chart wherein the root defines a center and each element defines an arc, each arc concentrically radiating from the center and stacked at a level corresponding to its hierarchical position with respect to the root;
receive a color scheme selection and apply such color scheme selection, respectively, to the arcs comprising the sunburst chart and list of elements digitally catalogued within the root; and
receive instructions to delete one or more elements digitally catalogued within the root.

5. The system of claim 4, wherein, responsive to receiving instructions to delete one or more elements, removing the arc corresponding to such element from the sunburst chart.

6. The system of claim 4, further comprising displaying bibliographic information defining an element catalogued within the root, responsive to receiving a selection of such element.

7. The system of claim 4, further comprising,
responsive to receiving a selection of an element catalogued within the root, generating a sunburst chart wherein the selected element defines a new root defining a center of the sunburst chart and each of any elements catalogued within the new root defines an arc, each arc concentrically radiating from the center and stacked at a level corresponding to its hierarchical position with respect to the new root.

8. A non-transitory, tangible computer-readable medium having stored thereon computer-executable instructions, which, when executed by a computer processor, enable performance of the method comprising:
receiving a selection of a stored item, the stored item defining a root;
generating, on a display of the computing device, a hierarchical visualization of the root and any elements digitally contained within the root;
listing each element digitally contained within the root;
receiving a selection of one or more elements catalogued within the root; displaying bibliographic information defining any selected elements.
generating, on the display, a hierarchical visualization of the one or more selected elements as a new root and any elements digitally contained within the new roots;
responsive to receiving a selection of the new root, regenerating the previously generated hierarchical visualization and list of one or more catalogued elements; and
responsive to receiving instructions to delete one or more elements catalogued in a root, transferring the one or more elements from storage within the root to the trash and regenerating the hierarchical visualization with such one or more elements removed;
wherein the hierarchical visualization, list of elements contained within the root, bibliographic information, and trash are consolidated for display within a single digital window.
